(19) United States
(12) Patent Application Publication
(10) Pub. No.: US 2026/0276404 A1
(43) Pub. Date: Sep. 17, 2026

(54) DYNAMIC MAPPING OF OUTDOOR YARDS

(71) Applicant: Mitsubishi Electric Automotive America, Inc., Northville, MI (US)

(72) Inventors: Ahmad A. Chalhoub, Northville, MI (US); Tetsuro Nishioka, Northville, MI (US); Eyad Zeino, Northville, MI (US); Astha Tiwari, Northville, MI (US)

(73) Assignee: Mitsubishi Electric Automotive America, Inc., Northville, MI (US)

(21) Appl. No.: 19/077,127

(22) Filed: Mar. 12, 2025

(51) Int. Cl. G01C 21/00; G01S 13/66; G06V 20/54

(52) U.S. Cl. CPC G01C 21/3841; G01S 13/66; G06V 20/54; G06V 2201/08

(57) ABSTRACT

Systems, methods, software, and devices are disclosed herein that provide for maintaining a digital twin of a state of operation of an outdoor yard of a distribution center indicative of changes in states of vehicles in the outdoor yard. In an embodiment, a yard management system is provided that includes a memory configured to store a dynamic map of the yard, and a processor coupled with executable instructions forming modules of the yard management system and configured to execute the modules to update the dynamic map of the outdoor yard. The modules may include an input interface, an output interface, a gate check-in module, a roadside-unit (RSU) module, and a gate check-out module. The input interface is configured to accept images of the outdoor yard, and the output interface is configured to output the dynamic map as updated by the gate check-in, RSU, and gate check-out modules.

### TECHNICAL FIELD

Aspects of the disclosure are related to the field of distribution center yard logistics, and in particular, to vehicle tracking in distribution center yards.

### BACKGROUND

Distribution centers play a key role in modern supply chain operations, facilitating the efficient receipt, storage, and dispatch of goods to various destinations. Unlike traditional warehouses, which primarily serve as long-term storage facilities, distribution centers are optimized for rapid throughput, ensuring products move seamlessly to end-users or retail locations. These facilities often employ advanced logistics and automation technologies to meet the demands of just-in-time delivery systems, minimizing delays and enhancing operational efficiency.

The operations within the indoor facilities of a distribution center are typically controlled and predictable. For example, indoor facilities often utilize advanced automated systems, such as automated guided vehicles (AGVs) and robotic storage systems, to optimize space utilization and facilitate efficient retrieval of goods, which ensures reliable and verifiable indoor operations. However, managing the operations of the outdoor yard presents unique challenges. Unlike the indoor facilities, the outdoor yard includes receiving and/or dispatching areas with multiple loading docks and unloading equipment to handle the arrival of goods from suppliers and/or shipping goods to their next destination. The outdoor yard can also include parking and loading zones for trucks and trailers, enabling a flow of vehicles in and out of the distribution center. In contrast with the indoor facility operated by the agents and autonomous machinery of the distribution center, the outdoor yard accepts trucks and trailers that belong to and are operated by customers and clients of the distribution center. These trucks and trailers can be operated by human drivers who lack training specific to the distribution center. In addition, there is no guarantee that the trucks and trailers of customers of the distribution center have sufficient sensors and transmitters to enable external control and/or tracking of their vehicles.

Furthermore, the outdoor yard is exposed to environmental factors such as weather and varying lighting conditions, complicating navigation, sensing, and control. The yard layout can also evolve over time, further increasing unpredictability in operations when considering the vast size of the yard. These challenges necessitate the development of systems and methods capable of reliably tracking and managing the outdoor yard's dynamic and erratic environment, and bridging the gap between the controlled indoor operations and the less predictable outdoor activities.

### SUMMARY

Technology is disclosed herein that improves the field of distribution center yard management by way of digitally mirroring operations of an outdoor yard of a distribution center. The enhanced mapping and management systems, devices, and methods may be employed to dynamically map a state of operation of an outdoor yard via a digital twin of the outdoor yard that reflects changes in states of vehicles within the outdoor yard.

In an implementation, a yard management system for maintaining a digital twin of a state of operation of an outdoor yard of a distribution center indicative of changes in states of vehicles in the outdoor yard is provided. The yard management system includes a memory configured to store a dynamic map of the yard including ingress, egress, and landmark locations of the outdoor yard, and a processor coupled with executable instructions forming modules of the yard management system and configured to execute the modules of the yard management system to update the dynamic map of the outdoor yard. The modules executed by the processor may include an input interface, an output interface, a gate check-in module, a roadside-unit (RSU) module, and a gate check-out module. The input interface is configured to accept images of a scene at an ingress location, an egress location, and landmark locations of the outdoor yard. The output interface is configured to output the updated dynamic map of the outdoor yard. The gate check-in module is configured to accept a first image of a vehicle entering the outdoor yard at the ingress location, extract from the first image visual features of one or a combination of visual appearance and visual markings on the vehicle, generate a digital identification number (digital ID) of the vehicle from the visual features of the first image, add to a list of vehicles present in the outdoor yard a digital representation of the vehicle identified by the digital identifier, and update the dynamic map by reflecting a state of the vehicle identified by the digital identifier on the dynamic map at the ingress location. The RSU module is configured to accept a second image of the vehicle at a corresponding landmark location of the landmark locations, extract from the second image the visual features of the vehicle, generate the digital identifier of the vehicle from the visual features of the second image, verify existence of the vehicle with the digital identifier in the list of vehicles present in the outdoor yard, and update the dynamic map by reflecting the state of the vehicle identified by the digital identifier on the dynamic map at the corresponding landmark location. The gate check-out module is configured to accept a third image of the vehicle exiting the outdoor yard at the egress location, extract from the third image the visual features of the vehicle, generate the digital identifier of the vehicle from the visual features of the third image, and remove the digital identifier of the vehicle from the list and the dynamic map of the outdoor yard.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a yard management system in an implementation.

FIG. 2 illustrates a yard mapping process employed by the system of FIG. 1 in an implementation.

FIG. 3 illustrates an operational sequence of steps performed by the yard management system of FIG. 1 in an implementation.

FIGS. 4A, 4B, 4C, and 4D illustrate an operating environment including a distribution center in an implementation.

FIG. 5 illustrates an operating environment including a distribution center in an implementation.

FIG. 6 illustrates an example information technology (IT) architecture in an implementation.

FIG. 7 illustrates a software block diagram in an implementation.

FIG. 8 illustrates a computing system suitable for implementing the various operational environments, architectures, processes, scenarios, and sequences discussed below with respect to the other Figures.

### DETAILED DESCRIPTION

The present disclosure relates to systems, devices, and methods for digitally mapping outdoor yards of distribution centers to track real-time changes within the outdoor yard. In various embodiments, a yard management system disclosed herein creates and manages a digital twin of the outdoor yard of a distribution center. In this context, the digital twin refers to a virtual representation of the outdoor yard. In creating the digital twin, the yard management system can virtually reflect states of operation within the outdoor yard, such as positions, movements, and statuses of vehicles (e.g., trucks, trailers) in the yard, that mirror a real-time state of operation of the outdoor yard. With the digital twin, autonomous yard management solutions can use the digital twin to carry out real-time yard management operations (e.g., navigation, status/location tracking) based on predictable and verifiable changes to the digital twin corresponding to actual movement in the outdoor yard.

In various embodiments, the yard management system generates the digital twin using a virtual map of the outdoor yard and digital identifiers (IDs) for each vehicle in the outdoor yard. The virtual map includes indications of ingress locations, egress locations, and landmark locations (e.g., loading zones, parking areas) and indications of the vehicles within the outdoor yard (digital IDs). The yard management system can dynamically update the virtual map to reflect states of the vehicles relative to the locations of the outdoor yard, which may help address the challenges of the erratic nature of outdoor yard operations, such as limited sensorial coverage, blind spots caused by vehicle or object obstructions, and equipment malfunctions. Moreover, the yard management system can provide real-time data suitable for controlling operations across various conditions and configurations based on the dynamic virtual map.

In various embodiments, the yard management system generates the digital identifiers for the vehicles tracked in the virtual map based on their visual appearance, such as shape and distinctive markings, rather than relying on random or algorithmic assignment. In some embodiments, the yard management system generates the digital identifiers by, additionally or alternatively, using spectral, optical, and/or thermal characteristics of the vehicles. Importantly, this approach ensures that the digital identifiers are stable, verifiable, and accurately tied to physical characteristics of the vehicle, and as such, the digital identifier can be created, duplicated, and verified to serve as an interface connecting the digital twin of the outdoor yard to its real-world counterpart.

The yard management system can advantageously maintain and verify the dynamic map of the yard with a limited number of cameras and sensors, and without the need for human intervention based on the above techniques for generating the digital identifiers. Cameras and sensors can be arranged at strategic locations advantageous for the operation of the yard, such as ingress and egress locations as well as other landmark locations, such as loading docks and designated parking spots. Because the digital identifier of a vehicle is verifiably recreated from the visual appearance of the vehicle in some embodiments, the dynamic map can be updated from images of a scene at locations that can be illuminated and/or protected from weather elements. For example, in various embodiments, cameras configured to image the ingress and egress locations of the outdoor yard may be protected by a structural roof, and ingress and egress locations are illuminated during the night hours. Similarly, loading docks and designated parking can be illuminated as well. Advantageously, the yard management system can maintain the digital twin of the yard with limited sensorial capability, in different weather and light conditions, and without the need for vehicles entering the outdoor yard to conform to specific types and tracking capabilities.

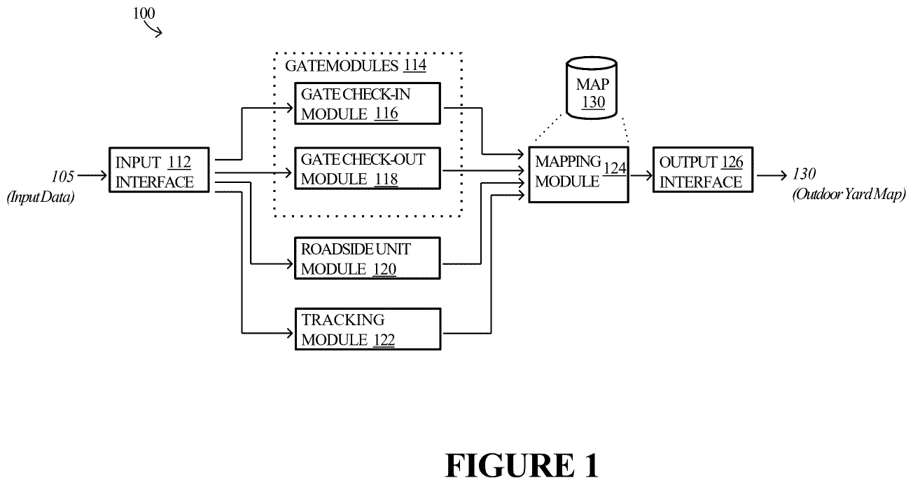

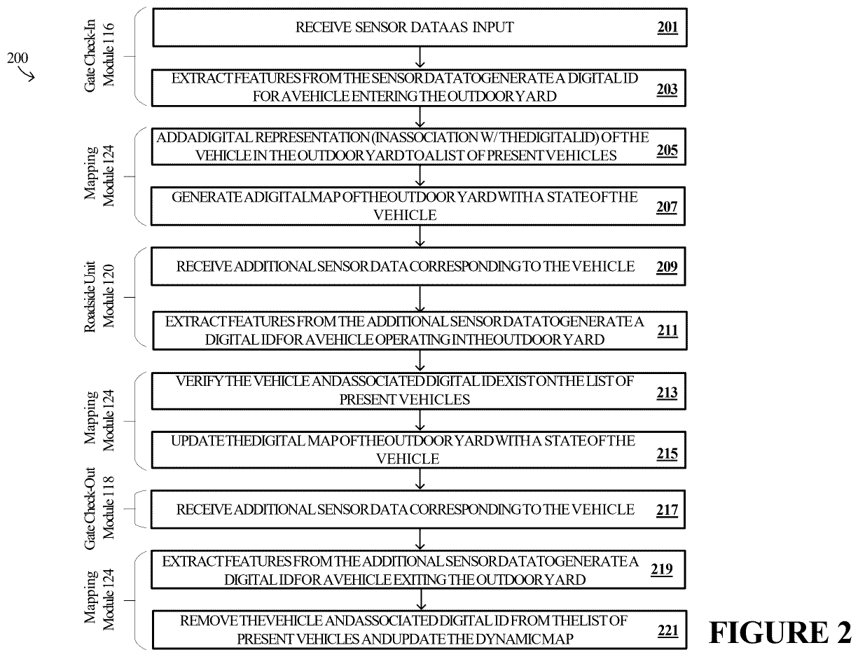

Turning now to the figures, FIG. 1 illustrates system 100 in an implementation, while FIG. 2 illustrates an outdoor yard mapping process associated with system 100.

Referring to FIG. 1, system 100 includes various elements that function in a coupled or cooperative manner to generate and maintain a digital twin of an outdoor yard of a distribution center indicative of changes to a state of operation of the outdoor yard. While the present disclosure generally pertains to outdoor yard management, such as outdoor yard mapping and vehicle tracking, it may be appreciated that the inventive concepts may apply as well to other environments and to other objects within the same or different environments.

Generally speaking, system 100 is representative of a system capable of capturing data (input data 105) associated with an outdoor yard of a distribution center, generating virtual representations (e.g., a digital twin) of the data to reflect a state of operation of the outdoor yard, and outputting (e.g., displaying on a graphical user interface) the virtual representations to facilitate outdoor yard management operations.

System 100 includes input interface 112, gate modules 114, roadside unit (RSU) module 120, tracking module 122, mapping module 124, and output interface 126. Together, system 100 receives input data 105 (e.g., sensor data, images), generates outdoor yard map 130 based on input data 105, and outputs outdoor yard map 130. More specifically, input interface 112 receives input data 105 from one or more sensors and cameras and provides input data 105 to gate modules 114 (including gate check-in module 116 and gate check-out module 118), RSU module 120, and tracking module 122 (also referred to collectively as “modules”).

In operation, the modules extract features from input data 105 to determine vehicles present in the outdoor yard, states of the vehicles within the outdoor yard, and the like, and provide the extracted features to mapping module 124. Based on the features, mapping module 124 generates asset records (e.g., a record for a detected asset (e.g., vehicle, object)) for the vehicles. Additionally, mapping module 124 generates digital identification numbers (digital identifiers or IDs) for identified vehicles, associates the assets records with corresponding digital identifiers, and updates a virtualized map of the outdoor yard to reflect the states of the vehicles present in the outdoor yard in association with their respective digital identifiers. Output interface 126 then receives the updated map from mapping module 124 and provides outdoor yard map 130 to one or more user devices (e.g., a computing device) for use in outdoor yard management processes, for example.

The elements of the yard management system 100 may be implemented in software and/or firmware executed by the circuitry of one or more processing devices. The processing devices may be implemented on a single computing device or distributed across multiple computing devices. Alternatively, or in addition, some or all of the functionality provided by any of the elements of system 100 may be implemented entirely via application-specific integrated circuits or other such special purpose devices. Some elements of system 100 may share functionality or perform different functionality in some embodiments.

System 100 employs an outdoor yard mapping process illustrated in FIG. 2 to receive input data 105 and generate and/or update outdoor yard map 130 reflective of a state of operation of an outdoor yard of a distribution center. Outdoor yard mapping process 200 may be implemented in program instructions in the context of the software, firmware, and/or hardware elements of system 100, such as modules formed by the program instructions (e.g., input interface 112, gate modules 114, RSU module 120, tracking module 122, output interface 126, mapping module 124). The program instructions, when executed by one or more processing devices of one or more suitable computing devices, direct the one or more computing devices to operate as follows, referring to the steps of FIG. 2 and in the singular to a computing device for the sake of clarity.

In operation, the computing device receives input data 105 as an input. (step 201). In various embodiments, input data 105 includes images captured of the outdoor yard, images captured of vehicles entering, exiting, and inside the outdoor yard, sensor data of the vehicles in the outdoor yard, and the like. The images may include raster images, vector images, photographic images, thermal images, and spectral images, among other types of images, as well as combinations and variations thereof. The sensor data may include light/spectral data, thermal data, optical data, electromagnetic data, motion data, and the like, captured by various sensors, such as cameras, radio frequency (RF) sensors, motion sensors, optical sensors, LiDAR, radar, thermal sensors, object tracking sensors, and the like.

Next, the computing device extracts features from input data 105 (step 203). In various embodiments, extracting features from input data 105 entails identifying values and properties of input data 105 (e.g., the images, the sensor data) to determine visual, physical, and/or kinematic features of a vehicle entering the outdoor yard. From the features of input data 105, the computing device determines visual appearances (e.g., size/dimensions, shape, orientation, color) of the vehicle and visual markings (e.g., logos, identification numbers, defects) on the vehicle. The computing device also determines positions and locations at which the vehicle is present within the outdoor yard (e.g., an ingress location in step 203) based on the features of input data 105 and may additionally determine a direction in which the vehicles are traveling (if applicable) to predict future locations of the vehicles.

Next, the computing device uses the extracted information to create an asset record for each vehicle detected. This may include an identifier (e.g., a value, a name) associated with the vehicle. Further, the computing device generates a digital identification number (digital identifier or ID) for the vehicle in the outdoor yard (step 203) based on the features extracted from input data 105 in association with the asset record. In this way, the computing device links the asset record with the digital identifier. In various embodiments, the digital identifier is representative of a virtual identifier associated with a particular vehicle. More specifically, the digital identifier may include a virtual or digital representation (e.g., a two-dimensional or three-dimensional digital rendering) of the vehicle as well as one or more numbers, values, or other indicators corresponding to the vehicle. The computing device may generate the digital identifier for the vehicle based on applying one or a combination of digital modeling processes to the features extracted from input data 105. Examples of the digital modeling processes include—but are not limited to—a three-dimensional modeling process, a vector graphics process, a spectral mapping process, and a thermal imaging process, among other modeling processes.

As a result, the digital identifier can be generated based on the features of input data 105 such that the digital identifier corresponds to visual appearances and visual markings of the vehicle. Additionally, or alternatively, the digital identifiers may correspond to other properties of the vehicle, such as thermal properties, optical properties, physical properties, kinematic properties, and the like.

Next, the computing device adds a digital representation of the vehicle detected in the outdoor yard to a list of present vehicles within the yard (step 205). The list of vehicles may include a table or other data structure holding all the vehicles and associated digital representations and digital identifiers that have entered and are currently present in the outdoor yard.

The computing device also determines a state of the vehicle based on the features extracted from input data 105. The state of the vehicle may refer to operational and/or locational information about the vehicle, such as a direction, orientation, and/or position of a vehicle at a given time, a location of the vehicle relative to locations of the outdoor yard, and an operational state (e.g., running, in-motion, stationary, loading/unloading) of the vehicle, among other information. The computing device associates the state of the vehicle with its digital identifier. As such, the computing device may reflect the state of the vehicle in the virtual or digital representation of the vehicles in association with the digital identifier.

Upon generating the digital identifiers and determining the state of the detected vehicle, the computing device generates (and/or updates) a digital map of the outdoor yard (step 207). In various embodiments, the digital map includes representations of the outdoor yard, such as representations of ingress locations, egress locations, and landmark locations within the outdoor yard, and representations of the vehicles in the outdoor yard in association with respective digital identifiers. In this way, the digital map virtually reflects real-time presence, position/location, and operations of vehicles within the outdoor yard. The computing device updates the digital map as new input data is captured to indicate changes in the state of operation of the outdoor yard with respect to present vehicles and respective states of operation.

Next, the computing device may receive additional sensor data corresponding to the vehicle (step 209). In this step, the additional sensor data may be captured by one or more sensors in a different location (e.g., a landmark location, e.g., a docking bay) than sensor(s) that captured input data 105 (e.g., an ingress location). For example, the vehicle may have moved beyond the ingress location of the outdoor yard into another area of the outdoor yard, such as a driveway area, a parking area, a docking area, or some other location.

Upon capturing additional data of the vehicle, the computing device again extracts features from the data, generates an asset record for the features extracted of the vehicle, and attempts to identify an existing asset record for the vehicle. This may entail matching this set of features with previously extracted features to determine a matching, or closest match, asset record, such as by comparing size, visual markings, visual appearance, and the like. Once a matching asset record is found, the computing device associates the asset record with the existing digital identifier of the vehicle (step 211).

After associating the digital identifier with the newly extracted features, the computing device verifies the vehicles existence on the list of present vehicles within the outdoor yard (step 213). To do so, the computing device may query the list for the digital identifier and the associated vehicle to determine whether the digital identifier matches a digital identifier in the list. Upon verifying that the digital identifier exists in the list, the computing device updates the digital map out of the outdoor yard with a state of the vehicle and its present location, position, and the like (step 215).

The computing device may receive additional sensor data corresponding to the vehicle at an egress location when the vehicle is exiting the outdoor yard at a later time (step 217). In this step, the additional sensor data may be captured by one or more sensors in a different location (e.g., an egress location) than sensor(s) that captured input data 105 (e.g., an ingress location). For example, the vehicle may have moved from the ingress location and/or one or more landmark locations and may be exiting the outdoor yard.

Upon capturing additional data of the vehicle, the computing device again extracts features from the data, generates another asset record for the features extracted of the vehicle, and attempts to identify an existing asset record for the vehicle. This may entail matching this set of features with previously extracted features to determine a matching, or closest match, asset record, such as by comparing size, visual markings, visual appearance, and the like. Once a matching asset record is found, the computing device associates the asset record with the existing digital identifier of the vehicle (step 219).

After generating the digital identifier, the computing device verifies the vehicles existence on the list of present vehicles within the outdoor yard by querying the list for the digital identifier and the associated vehicle to determine whether the digital identifier matches a digital identifier in the list. Upon verifying that the digital identifier exists in the list, the computing device removes the digital identifier and the vehicle from the list and updates the digital map out of the outdoor yard to remove the vehicle from the digital map (step 221).

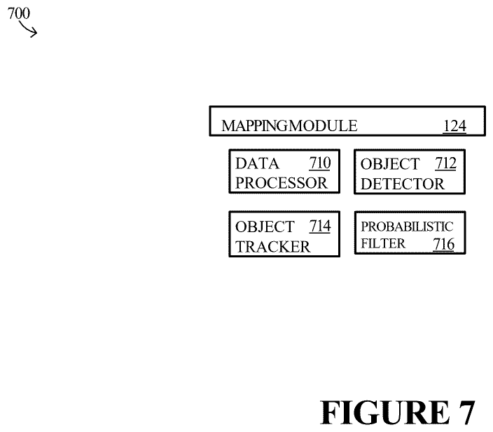

In some embodiments, the computing device may predict presence, position/location, trajectory, and operations of vehicles within the outdoor yard based on the features of input data 105 at times when there is limited sensor availability. Limited sensor availability may occur due to a lack of sensor presence in an area of the outdoor yard, a lack of visibility of vehicles in inclement weather, or some hardware, software, or firmware error (e.g., network connectivity). To predict states of the vehicles, the computing device may implement a tracking process (e.g., via Kalman filters, e.g., implemented by tracking module 122) to predict a trajectory of a vehicle based on features extracted from input data 105. Then, the computing device can update the digital map based on such predictions. Additional information regarding such tracking and predicting is discussed below with respect to FIG. 7.

Referring back to FIG. 1, the following describes a specific application of the outdoor yard mapping process 200 by the elements of system 100. In operation,

In operation, input interface 112 receives input data 105 as an input from sensors within and around the outdoor yard of the distribution center. In various embodiments, input data 105 includes images captured of the outdoor yard, images captured of vehicles entering, exiting, and inside the outdoor yard, sensor data of the vehicles in the outdoor yard, and the like. The images may include raster images, vector images, photographic images, thermal images, and spectral images, among other types of images, as well as combinations and variations thereof. The sensor data may include light/spectral data, thermal data, optical data, electromagnetic data, motion data, and the like, captured by various sensors, such as cameras, radio frequency (RF) sensors, motion sensors, optical sensors, LiDAR, radar, thermal sensors, object tracking sensors, and the like.

Upon receiving input data 105, input interface 112 provides the input data 105 to gate modules 114, to RSU module 120, and to tracking module 122. Gate modules 114 include gate check-in module 116 and gate check-out module 118, which are configured to perform outdoor yard mapping processes associated with ingress and egress locations of the outdoor yard, respectively. RSU module 120 is configured to perform outdoor yard mapping processes associated with landmark locations within the outdoor yard. Tracking module 122 is configured to perform tracking and sensing operations of the outdoor yard mapping processes associated with various locations within the outdoor yard.

Gate check-in module 116 extracts features from input data 105 corresponding to ingress locations of the outdoor yard, and gate check-out module 118 extracts features from input data 105 corresponding to egress locations of the outdoor yard. In extracting the features, gate check-in module 116 and gate check-out module 118 identify properties of input data 105 captured at the ingress and egress locations, respectively, and as a result, the gate modules identify vehicles entering and exiting the outdoor yard, respectively. Additionally, the gate modules identify visual appearances, markings, properties, and characteristics of the vehicles in respective locations.

The gate modules each generate asset records (e.g., a record for a detected asset (e.g., vehicle, object)) for the vehicles based on respective extracted features. Gate check-in module 116 generates digital identification numbers (digital identifiers or IDs) for identified vehicles and associates respective assets records with corresponding digital identifiers. When gate check-out module 118 captures data and extracts features about vehicles exiting the outdoor yard, gate check-out module 118 may create further asset records based on respective extracted features. Then, gate check-out module 118 can identify similar, or matching, asset records based on comparing extracted features to features associated with other asset records. Upon finding matching asset records, gate check-out module 118 associates the further asset records with corresponding digital identifiers.

In addition, the gate modules determine states of the vehicles based on the features extracted from input data 105. The states of the vehicles may refer to operational and/or locational information about the vehicles, such as a direction, orientation, and/or position of a vehicle at a given time, a location of the vehicle relative to locations of the outdoor yard, and an operational state (e.g., running, in-motion, stationary, loading/unloading) of the vehicle, among other information.

Upon generating the digital identifiers and determining the states of the vehicles, the gate modules generate (and/or update) a portion of outdoor yard map 130 (e.g., a digital map of the outdoor yard) corresponding to ingress and egress locations of the outdoor yard, respectively. In particular, this may entail each gate module generating representations of the states and populating the portion of the digital map with the representations at locations of the digital map that correspond to real-world locations where the vehicles are detected. Accordingly, in various embodiments, the digital map includes representations of the outdoor yard, such as representations of ingress locations, egress locations, and landmark locations within the outdoor yard, and representations of the vehicles in the outdoor yard in association with respective digital identifiers.

By way of example, when a vehicle enters the outdoor yard through an ingress location, gate check-in module 116 receives sensor data and extracts features from the sensor data. Gate check-in module 116 creates an asset record and a corresponding digital identifier for the vehicle. Gate check-in module 116 then adds the vehicle (and its associated digital identifier) to a list of present vehicles. Further, gate check-in module 116 updates outdoor yard map 130 to indicate changes in the state of operation of the outdoor yard with respect to vehicles present at the ingress location and respective states of operation of the vehicles. In some embodiments, gate check-in module 114 instead provides an indication of the vehicle, its digital identifier, and its state to mapping module 124, then mapping module 124 updates outdoor yard map 130.

For a vehicle exiting the outdoor yard at an egress location, gate check-out module 118 receives sensor data and extracts features from the sensor data. Gate check-out module 118 may create another asset record for the vehicle based on the features captured of the vehicle. More particularly, gate check-out module 118 may capture different features of the vehicle, and thus, might not recognize the vehicle without additional processing. Then, gate check-out module 118 identifies a similar, or matching, record and associates the asset record with an existing digital identifier of the vehicle. Upon determining the vehicle is exiting or has exited the outdoor yard, gate check-out module 118 removes the vehicle (and its associated digital identifier) from the list of present vehicles and updates outdoor yard map 130 to reflect that the vehicle no longer exists in the outdoor yard. In some embodiments, gate check-out module 118 instead, or in addition, provides an indication of removal to mapping module 124 for mapping module 124 to update outdoor yard map 130 to remove the representation of vehicle from the digital map.

With respect to vehicles present in the outdoor yard beyond an ingress location, RSU module 120 extracts features from input data 105 corresponding to landmark locations (e.g., loading docks, parking areas) of the outdoor yard. RSU module 120 identifies properties of input data 105 captured at one or more landmark locations, and as a result, identifies vehicles at the landmark locations as well as visual appearances, markings, properties, and characteristics of the vehicles in respective locations. RSU module 120 creates asset records for the vehicles captured at the landmark locations based on respective features. RSU module 120 compares the features (and associated asset records) to existing asset records and associated digital identifiers, then links matching asset records with associated digital identifiers. If the asset records do not match an asset record in the list of present vehicles, RSU module 120 may output an error to output interface 126. In some embodiments, RSU module 120 additionally creates a new digital identifier for the asset record/vehicle.

If the asset records match asset records in the list of present vehicles, RSU module 120 updates outdoor yard map 130 with a state of the vehicle detected at the landmark location. Additionally or alternatively, RSU module 120 provides an indication thereof to mapping module 124, and mapping module 124 determines states of the vehicles based on the features extracted from input data 105. Then, mapping module 124 updates outdoor yard map 130 to indicate changes in the state of operation of the outdoor yard with respect to vehicles present in landmark locations and respective states of operations of such vehicles.

Tracking module 122 also receives input data 105 and extracts features from input data 105 to estimate a kinematic state of an object in the outdoor yard and to track the movement of vehicles within the outdoor yard. More specifically, to do so, tracking module 122 includes a sensing unit and an assignment unit. The sensing unit is configured to receive input data 105 and to estimate a kinematic state of an object in the outdoor yard indicative of a location and/or a velocity of the object. The assignment unit is configured to associate the kinematic state of the object with a digital identifier of a vehicle, track the movement of the vehicle associated with the digital identifier within the outdoor yard, and update outdoor yard map 130 based on the tracked movement of the vehicle having the digital identifier. The assignment unit may additionally, or instead, update outdoor yard map 130 by mapping dimensions and orientations of the vehicle on outdoor yard map 130. Importantly, tracking module 122 may be used to re-create a digital representation of a vehicle operating in the outdoor yard if there is an error and the vehicle does not appear on outdoor yard map 130 (e.g., due to a sensor failure, a computing error, or the like), at least temporarily.

To determine the dimensions and orientations of the vehicle, the sensing unit may estimate an extended state of the object indicative of a dimension and/or an orientation of the object. To do so, the sensing unit identifies measurements of the object in input data 105 and executes a probabilistic filter tracking a joint probability of the expanded state of the object estimated by a motion model of the object and a measurement model of the object. In various embodiments, the measurement model includes a center-truncated distribution having truncation intervals providing smaller probability for the one or multiple measurements at the center of the center-truncated distribution inside of the truncation intervals and larger probability for the measurements outside of the truncation intervals.

The center-truncated distribution is a truncation of underlying untruncated Gaussian distribution according to the truncation intervals. In executing the probabilistic filter, the sensing unit is configured to estimate the center-truncated distribution that fits the one or multiple measurements and to produce mean and variance of the underlying Gaussian distribution corresponding to the center-truncated distribution, such that the mean of the underlying Gaussian distribution indicates the position of the object in the expanded state and the variance of the underlying Gaussian distribution indicates the dimension and the orientation of the object in the expanded state.

In various embodiments, tracking module 122 also includes a Kalman filter and tracks vehicles using a process model (e.g., a motion model) of the vehicle subject to process noise and a measurement model of the measurements of the active sensor subject to measurement noise. The Kalman filter may include a compound measurement model with different variances of the measurement noise to adapt the Kalman filter to different qualities of the measurements.

After any updates to outdoor yard map 130, output interface 126 obtains an updated version of the digital map at storage (e.g., a memory, a database) and provides outdoor yard map 130 downstream to one or more user devices capable of performing yard management operations, for example. Outdoor yard map 130 includes the digital map that shows representations of the vehicles present in the outdoor yard at respective locations. Thus, outdoor yard map 130 serves as a digital twin of the outdoor yard that reflects a state of operation of the outdoor yard in real-time. Downstream user devices can utilize outdoor yard map 130 to track vehicle locations, track vehicle movements and operations, identify a capacity of the outdoor yard, and the like.

In some embodiments, additional or fewer modules and interfaces may be utilized by system 100 to perform outdoor yard mapping processes, such as outdoor yard mapping process 200. Some modules and interfaces may share functionality or utilize different variations or combinations of functionality in digital mapping of the outdoor yard. Furthermore, additional modules may be included for object sensing/detecting, object tracking, trajectory projection, and the like. As such, input data 105 may be distributed to one or more different modules, or combinations or variations of modules, to dynamically update a digital map and produce outdoor yard map 130 reflective of real-time changes to a state of operation of an outdoor yard.

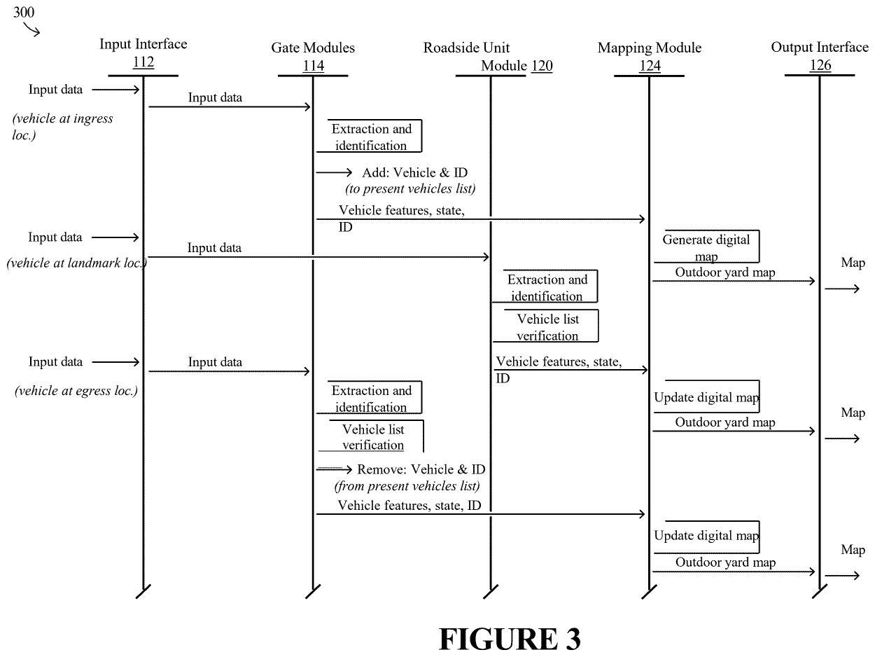

FIG. 3 illustrates operational sequence 300 representative of a set of steps performed by elements of system 100 in an embodiment. For example, operational sequence 300 includes steps performed by input interface 112, gate modules 114, RSU 120, mapping module 124, and output interface 126 of system 100.

To begin operational sequence 300, input interface 112 receives input data (e.g., input data 105) captured of a vehicle entering an outdoor yard at an ingress location. The input data may include images captured of the outdoor yard, images captured of the vehicle entering the outdoor yard, sensor data of the vehicles in the outdoor yard, and the like. The images may include raster images, vector images, photographic images, thermal images, and spectral images, among other types of images, as well as combinations and variations thereof. The sensor data may include light/spectral data, thermal data, optical data, electromagnetic data, motion data, and the like, captured by various sensors, such as cameras, radio frequency (RF) sensors, motion sensors, optical sensors, LiDAR, radar, thermal sensors, object tracking sensors, and the like. Upon receiving the input data from one or more sensors, input interface 112 provides the input data to gate modules 114.

Gate modules 114 include gate check-in module 116 and gate check-out module 118, which are configured to perform outdoor yard mapping processes associated with ingress and egress locations of the outdoor yard, respectively. Based on the input data corresponding to a vehicle at an ingress location of the outdoor yard, gate check-in module 116 extracts features from the input data to identify properties of the vehicle detected at the ingress location. For example, gate check-in module 116 identifies visual appearances, markings, properties, and characteristics of the vehicle at the ingress location as well as a position, orientation, location, and kinematic information of the vehicle.

Then, gate check-in module 116 creates an asset record and a corresponding digital identifier for the vehicle based on its visual appearance, among other properties and characteristics. The digital identifier includes a unique identifier corresponding to the visual appearance, properties, and/or characteristics of the vehicle. Gate check-in module 116 adds the vehicle and its associated digital identifier to a list of vehicles present within the outdoor yard.

Gate check-in module 116 also determines a state of the vehicle based on the features extracted from the input data. States of the vehicles may refer to operational and/or locational information about the vehicles, such as a direction, orientation, and/or position of a vehicle at a given time, a location of the vehicle relative to locations of the outdoor yard, and an operational state (e.g., running, in-motion, stationary, loading/unloading) of the vehicle, among other information.

Upon generating the digital identifier and determining the state of the vehicle entering the outdoor yard, gate check-in module 116 provides indications of the vehicle features, the digital identifier, and the state to mapping module 124 to generate (and/or update) a portion of a digital map of the outdoor yard (e.g., outdoor yard map 130) corresponding to the ingress location of the outdoor yard. Mapping module 124 maps the vehicle, or a digital/virtual representation thereof, on a digital twin of the outdoor yard map. Then, mapping module 124 provides the map to output interface 126 for use (e.g., display).

Operational sequence 300 continues with input interface 112 receiving additional input data corresponding to a vehicle detected at a landmark location within the outdoor yard. For input data associated with landmark locations, input interface 112 provides the input data to RSU module 120. RSU module 120 extracts features from the input data to identify properties of the vehicle detected at the landmark location. For example, RSU 120 identifies visual appearances, markings, properties, and characteristics of the vehicle at the landmark location as well as a position, orientation, location, and kinematic information of the vehicle.

Then, RSU module 120 creates another asset record based on the features extracted by RSU module 120. RSU module 120 compares the asset record to other asset records among the list of vehicles present in the outdoor yard to identify a similar or matching asset record. Once RSU module 120 finds a closest match asset record, RSU module 120 associates the asset record with the existing digital identifier for the vehicle and verifies that the digital identifier exists in the list of vehicles present within the outdoor yard.

Additionally, RSU module 120 determines a state of the vehicle based on the features extracted from the input data. Upon determining the digital identifier and the state of the vehicle entering the outdoor yard, RSU module 120 provides indications of the vehicle features, the digital identifier, and the state to mapping module 124 to generate (and/or update) a portion of a digital map of the outdoor yard corresponding to the landmark location of the outdoor yard. Mapping module 124 maps the vehicle, or a digital/virtual representation thereof, on a digital twin of the outdoor yard map. Then, mapping module 124 provides the map to output interface 126 for use (e.g., display).

Operational sequence 300 continues further with input interface 112 receiving additional input data corresponding to a vehicle detected at an egress location of the outdoor yard. For such input data, input interface 112 provides the input data to gate check-out module 118 of gate modules 114. Gate check-out module 118 extracts features from the input data, then creates an asset record based on the extracted features. Gate check-out module 118 compares the asset record with asset records among the list of vehicles present in the outdoor yard to determine a closest match. Upon determining a closest match asset record, gate check-out module 118 associates the asset record with the existing corresponding digital identifier for the vehicle. Gate check-out module 118 verifies whether the digital identifier matches an identifier on the list, and if so, gate check-out module 118 removes the digital identifier from the list upon detecting that the vehicle successfully exited the outdoor yard.

Gate check-out module 118 provides an indication of the removal (e.g., the vehicle's state) along with the vehicle and its associated digital identifier to mapping module 124. Then, based on the indication that the vehicle has exited the outdoor yard, mapping module 124 updates the outdoor yard map by removing the digital representation of the vehicle from the digital twin mapping of the outdoor yard. Mapping module 124 then provides the updated outdoor yard map to output interface 126.

It may be appreciated that variations and combinations of the above steps may be repeated for any vehicles detected and tracked throughout the outdoor yard by various sensors within the outdoor yard. Accordingly, in various embodiments, the digital outdoor yard map includes representations of the outdoor yard, such as representations of vehicles detected at the ingress, landmark, and egress locations of the outdoor yard in association with respective digital identifiers at various times to reflect real-time operations of the outdoor yard.

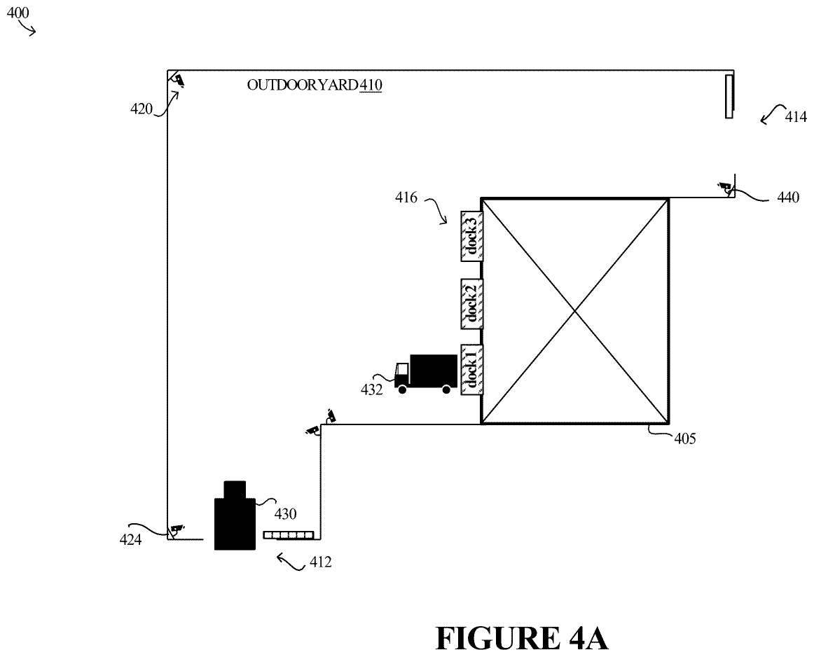

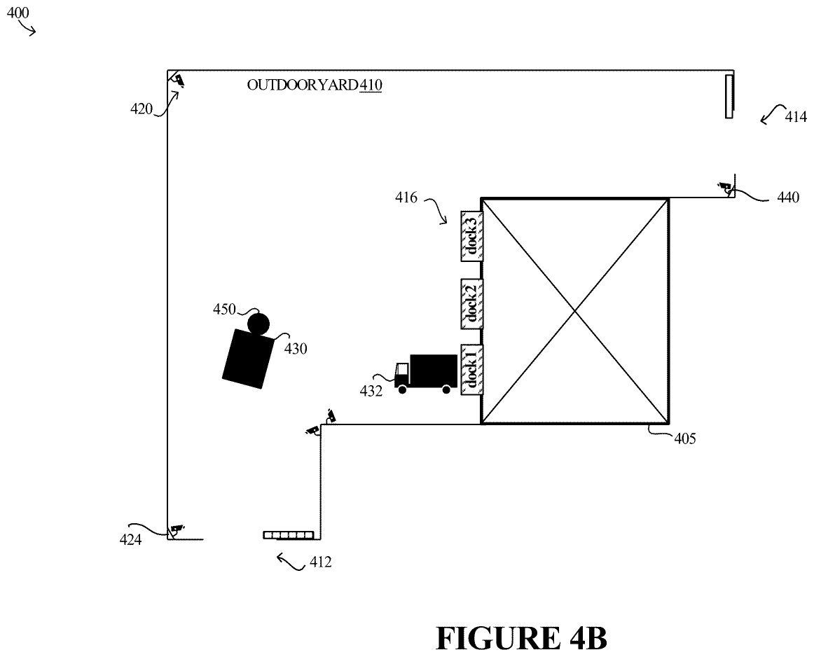

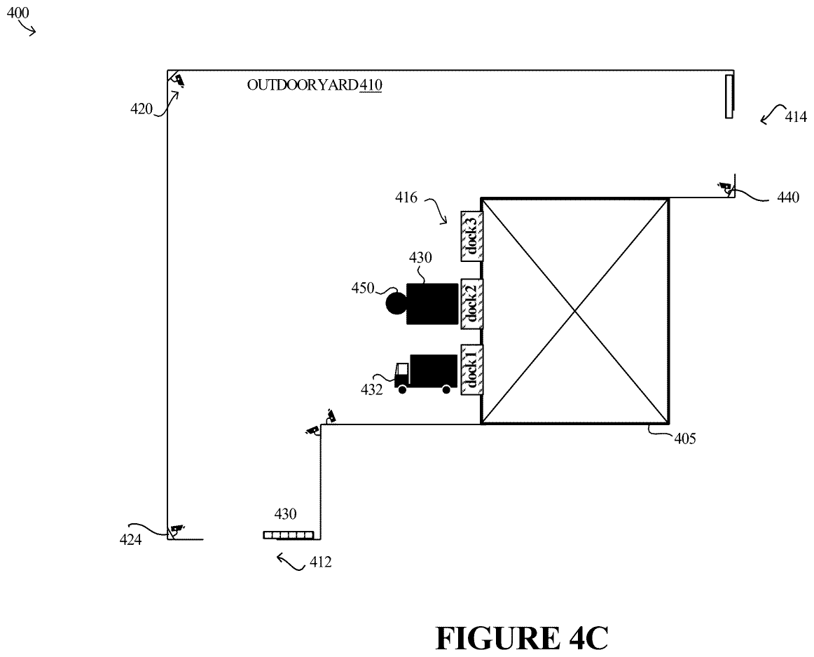

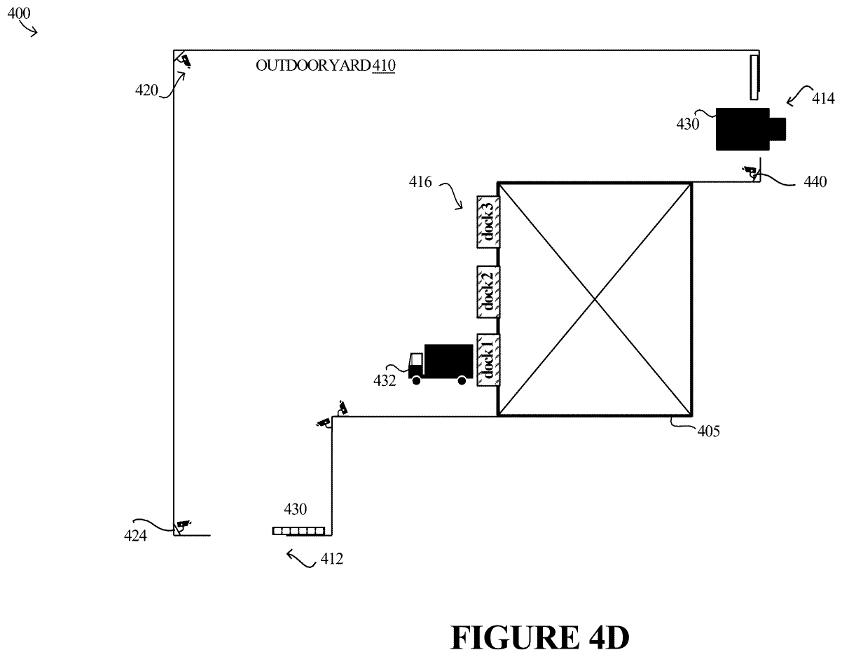

FIGS. 4A, 4B, 4C, and 4D illustrate operating environment 400 representative of a distribution center in an embodiment. The distribution center includes both indoor facility 405 and outdoor yard 410 in which various supply chain operations are performed. Indoor facility 405 is representative of a building including offices and warehouses for secure, indoor storage. Outdoor yard 410 is representative of a yard including receiving and/or dispatching areas with multiple loading docks and unloading equipment to handle the arrival of goods from suppliers and/or shipping goods to their next destination. Outdoor yard 410 also includes parking and loading zones for trucks and trailers, enabling a flow of vehicles in and out of the distribution center.

FIGS. 4A, 4B, 4C, and 4D each include a top-down view of operating environment 400 that shows vehicle 430 in different states at various times. Operating environment 400 also shows indoor facility 405 and ingress location 412, egress location 414, and docking area 416 of outdoor yard 410, as well as various sensors positioned around and inside outdoor yard 410, such as sensor 420. Ingress location 412 is representative of an entry point to outdoor yard 410 at which vehicles enter outdoor yard 410. Docking area 416 is representative of a landmark location of outdoor yard 410 including several docks at which vehicles are parked, loaded, unloaded, and the like at a designated bay of outdoor yard 410. Egress location 414 is representative of an exit point of outdoor yard 410 at which vehicles leave outdoor yard 410.

Numerous sensors may be present at or around outdoor yard 410, and specifically, at ingress location 412 to detect vehicles entering outdoor yard 410 at ingress location 412, at docking area 416 to detect vehicles parked and/or operating at specific docks, and at egress location 414 to detect vehicles leaving outdoor yard 410 at egress location 414. The sensors capture images and data of vehicles that can be processed to determine information about the vehicles, such as visual appearance of the vehicles, markings on the vehicles, and other characteristics of the vehicles (e.g., thermal characteristics, optical characteristics, velocity).

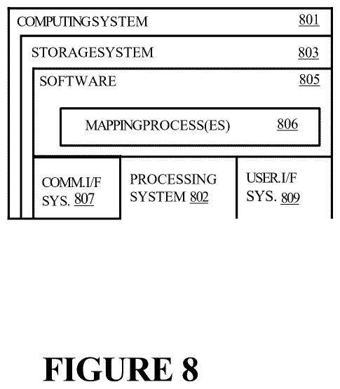

In various embodiments, outdoor yard 410 includes both active and passive sensors configured to capture different types of data. Active sensors refer to devices that generate and emit their own signals or energy, which then interact with a target object (e.g., vehicle). The active sensors measure energy reflected or returned from the target object to derive information. To that end, the active sensors actively send out a signal (e.g., electromagnetic waves) and then measure how that signal is altered by interaction with the target. Examples of active sensors include a radar that emits radio waves and measures the reflection to determine the distance, speed, and other properties of objects, a LiDAR that sends out laser pulses and measures the time it takes for the pulses to return after reflecting off a surface, and an ultrasonic sensor that emits sound waves and measure the time it takes for the echoes to return, among other types of sensors. Passive sensors detect natural energy that is emitted or reflected by objects. They do not emit any energy themselves; instead, they measure the energy that is already present. To that end, the passive sensors rely on external sources of energy, such as sunlight or thermal radiation. Examples of passive sensors include photographic (RGB) cameras that capture visible light reflected from objects, and infrared sensors that measure thermal radiation emitted by objects. The passive sensors are simpler and often require less power because they do not need to generate their own signal, but their performance can be affected by the availability or strength of the external energy source. The sensors provide respective images and data as input to a yard management system (e.g., system 100) capable of performing outdoor yard mapping processes, such as outdoor yard mapping process 200 of FIG. 2, an example of which is provided by computing system 801 of FIG. 8.

Referring first to FIG. 4A, FIG. 4A represents a first time at which vehicle 430 enters outdoor yard 410 through ingress location 412. Upon entering at ingress location 412, sensor 424 captures images of vehicle 430 and provides the images to the yard management system. In some embodiments, sensor 424 includes a camera capable of capturing images of vehicle 430. In some embodiments, sensor 424 includes a different type of sensor, such as a LiDAR sensor, an ultrasonic sensor, an RF sensor, or a motion sensor, among other types of sensors. Additional sensors of various types may also be included at ingress 412.

The yard management system receives the images from sensor 424 and extracts features from the images to determine the visual appearance, among other characteristics, of vehicle 430. The yard management system then generates an asset record and an associated digital identifier for vehicle 430 based on the visual appearance of vehicle 430. Additionally, or alternatively, the yard management system generates the asset record and the digital identifier based on other properties or characteristics of vehicle 430, such as thermal characteristics, optical characteristics, and the like. Upon detecting vehicle 430 and associating a digital identifier with vehicle 430, the yard management system adds vehicle 430 to a list of vehicles within outdoor yard 410. This may entail generating a digital representation of vehicle 430 in association with the digital identifier and adding the digital representation to the list of present vehicles.

Additionally, the yard management system determines a state of vehicle 430 based on the features extracted from the images. The states of the vehicles may refer to operational and/or locational information about the vehicles, such as a direction, orientation, and/or position of a vehicle at a given time, a location of the vehicle relative to locations of the outdoor yard, and an operational state (e.g., running, in-motion, stationary, loading/unloading) of the vehicle, among other information. The yard management system associates the state of vehicle 430 with its digital identifier. Using the state and the digital identifier of vehicle 430, the yard management system updates a portion of a digital map (e.g., outdoor yard map 130, outdoor yard map 130) of outdoor yard 410 corresponding to ingress location 412 to reflect the presence and state of vehicle 430 with respect to outdoor yard 410.

Referring next to FIG. 4B, FIG. 4B represents a second time (following the first time) at which vehicle 430 is being towed by a yard dog 450 (e.g., a machine in outdoor yard 410 configured to tow a trailer or other vehicles to a designated area) to docking area 416. While yard dog maneuvers vehicle 430, one or more sensors (e.g., sensor 420) in outdoor yard 410 may capture data regarding the position, orientation, movement, and the like, of vehicle 430 to track the location and operations of vehicle 430. The sensors provide captured data to the yard management system, and the yard management system creates another asset record based on the data captured by the sensor(s). The yard management system compares the data in this asset record with existing asset records to identify vehicle 430. Upon finding a closest match asset record generated when vehicle 430 passed through ingress location 412, the yard management system associates this asset record with the digital identifier of vehicle 430. Then, the yard management system verifies that the digital identifier is on the list of vehicles present in outdoor yard 410. After confirming the digital identifier exists on the list, the yard management system determines a state of vehicle 430 and updates the digital map to reflect the current position, orientation, and operation of vehicle 430.

Referring next to FIG. 4C, FIG. 4C represents a third time (following the first and second times) when vehicle 430 is parked at a bay at docking area 416 by yard dog 450. While approaching and at docking area 416, one or more sensors in outdoor yard 410 may capture data regarding the position, orientation, movement, and the like, of vehicle 430 to track the location and operations of vehicle 430. Similarly, one or more sensors may capture data corresponding to vehicle 432 also parked at a bay of docking area 416. The sensors capture images and/or sensor data of vehicles 430 and 432 and provide such data to the yard management system. The yard management system performs similar mapping processes as above using the data from the sensors to identify a digital identifier associated with vehicles 430 and 432. The yard management system also verifies that the digital identifier of vehicle 432 matches a digital identifier on the list of vehicles present in outdoor yard 410. Assuming the digital identifier exists in the list, the yard management system determines a state of vehicle 432, then updates the digital map.

Referring next to FIG. 4D, FIG. 4D represents a fourth time (following the first, second, and third time) when vehicle 430 exits outdoor yard 410 via egress location 414. Upon vehicle 430 exiting outdoor yard 410 at egress location 414, one or more sensors (e.g., sensor 440) detects vehicle 430 at egress location 414, captures images and/or sensor data of vehicle 434,and provides such data to the yard management system. The yard management system performs similar mapping processes as above using the data from the sensors to identify a digital identifier associated with vehicle 430. The yard management system identifies the digital identifier among the list of digital identifiers of vehicles present in outdoor yard 410, and removes the digital identifier associated with vehicle 430 from the list. Then, the yard management system updates the digital map to remove vehicle 430 from the digital map.

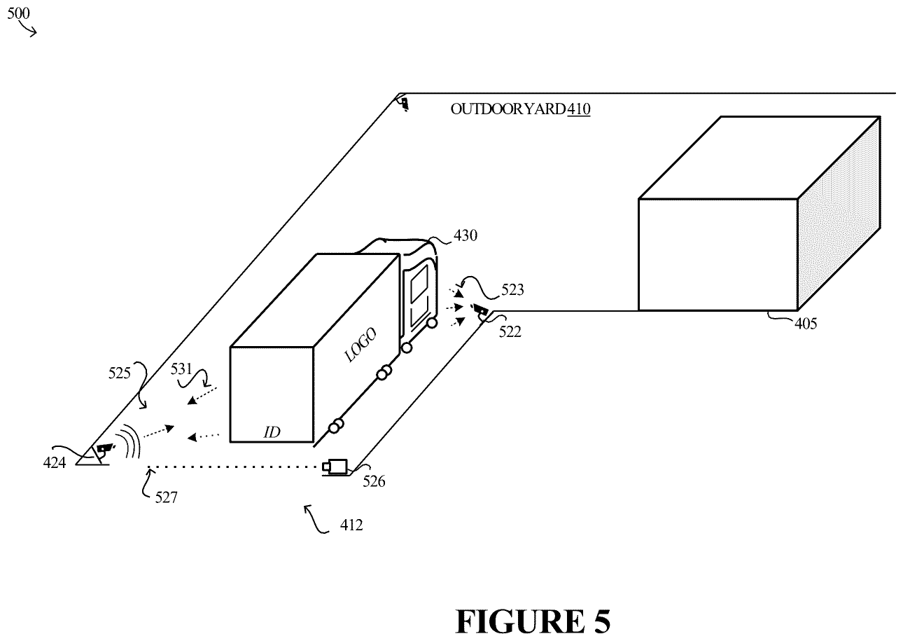

FIG. 5 shows an isometric view of outdoor yard 410 in operating environment 500 focusing on ingress location 412 and vehicle 430 located near ingress location 412 within outdoor yard 410. As shown in FIG. 5, vehicle 430 is representative of a semi-truck towing a trailer. The trailer may include a logo, or other markings, as well as one or more identifiers, such as a license plate number, a company identification number, a carrier identification number, a department identification number (e.g., U.S. Department of Transportation (USDOT) identification number), and the like. As vehicle 430 passes through a gate at ingress location 412, sensors 424 and 526 capture information about vehicle 430, such as the dimensions and visual appearance of vehicle 430, a type of vehicle 430, and markings or indications on vehicle 430.

In at least this example, sensor 526 is representative of a motion sensor that emits signals 527 from one point of ingress location 412 to another point of ingress location 412. In response to sensor 526 detecting vehicle 430 based on a disturbance in signal 527, sensor 526 outputs an indication of vehicle 430 at ingress location 412 to the yard management system. Sensor 424 is representative of a radio sensor (an active sensor) that emits signals 525 toward vehicle 430 and receives signals 531 from vehicle 430. In response to receiving signals 531 returned from vehicle 430, sensor 424 outputs data based on signals 531 to the yard management system indicative of a presence of vehicle 430 at ingress location 412. Sensor 522 is representative of an infrared sensor (a passive sensor) that captures signals 523 reflected off vehicle 430 upon passing by sensor 522 in outdoor yard 410. In response to receiving signals 523, sensor 522 provides data based on signals 523 to the yard management system.

Upon receiving sensor data from one or more of sensors 522, 424, and 526, the yard management system functions as described above with respect to FIG. 4A to perform outdoor yard mapping processes and track states of vehicle 430 as vehicle 430 enters and operates in outdoor yard 410.

It may be appreciated that additional, fewer, or different sensors may be placed around outdoor yard 410 to capture data to carry out such yard mapping processes. For examples, some embodiments are based on the understanding that there is a need to enable continuous tracking of the vehicles in the yard from measurements of the state of the yard having blind spots resulting from one or a combination of limited sensorial capability of a sensor arrangement in the yard, malfunctioning of one or multiple sensors and/or at least temporally blocking of a sensor by controlled or uncontrolled motion of a vehicle and other objects in the yard. To that end, some embodiments use the measurements of the active sensors to estimate not only the kinematic state of the objects in the yard but also an expanded state indicative of one or a combination of a dimension and an orientation of the object in the yard. The expanded state allows some embodiments to associate the kinematic state of the object with the digital identifier of the vehicle having the type and dimensions matching the estimated expanded state of the object. Doing this in such a manner may advantageously allow to disambiguate vehicles located on a single line of view of active sensors, thereby reducing the number of sensors arranged to sense the outdoor yard.

Furthermore, some embodiments are based on recognizing that the busy and hectic movement during the operation of the outdoor yard may result in blind spots that may disrupt the continuous tracking of the vehicles in the yard. To that end, some embodiments track the vehicle using probabilistic filters, like Kalman filters, that track the vehicle not only based on sensing their current kinematic state but also predicting their state using motion models of the vehicles. Additionally, or alternatively, some embodiments are based on recognizing that at different stages of the operation of the yard, the process model may be more reliable than the measurement model. That could happen when, for example, the vehicle is blocked by another vehicle in the yard preventing the active sensor from acquiring the measurements of the state of the vehicle. To address this problem, some embodiments use the compound measurement model with different variances of the measurement noise to adapt the performance of the Kalman filter to different qualities of the measurements.

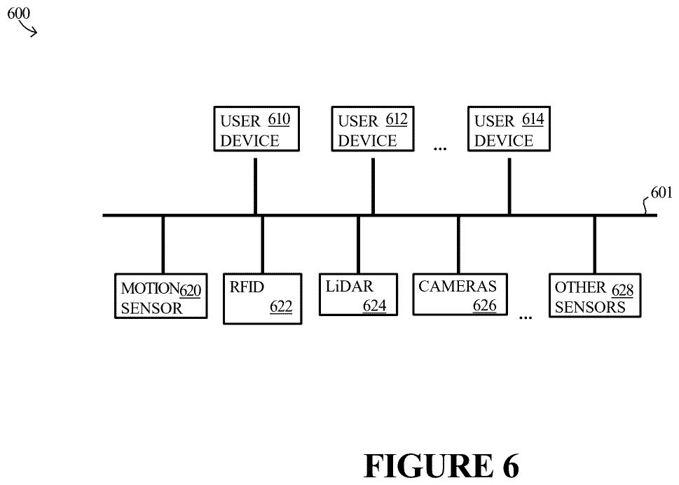

FIG. 6 illustrates IT architecture 600 that is representative of an example infrastructure of a system by which outdoor yard mapping processes are performed. IT architecture 600 includes network 601 and various elements coupled to network 601, such as user devices 610, 612, and 614, motion sensor 620, RFID 622, LiDAR 624, cameras 626, and other sensors 628.

In various embodiments, user devices 610, 612, and 614 are representative of computing devices capable of performing outdoor yard mapping processes, such as outdoor yard mapping process 200 of FIG. 2, and/or yard management processes, such as vehicle logistics operations. Examples of user devices 610, 612, and 614 may include desktop and laptop computers, tablet computers, mobile computers, smart phones, server computers, web servers, cloud computing platforms, and data center equipment, as well as any other type of physical or virtual server machine, container, and any variation or combination thereof, an example of which is provided by computing system 801 of FIG. 8.

Each of user devices 610, 612, and 614 are in communication with each other and with various sensors via network 601. Network 601 is representative of a communication network instantiated by networking hardware at a distribution center. For example, network 601 is a local network by which user devices 610, 612, and 614 communicate with one or more sensors to receive sensor data therefrom.

Motion sensor 620, RFID 622, LiDAR 624, cameras 626, and other sensors 628 are representative of a sensor included in an outdoor yard (e.g., outdoor yard 410) of a distribution center. In particular, each sensor captures data from vehicles in the outdoor yard and provides the data to one or more of user devices 610, 612, and 614 via network 601 for the user device(s) to process the data. Upon processing the data captured by the sensors, user devices 610, 612, and 614 detect a presence of a vehicle at a particular location within the outdoor yard, identify visual, physical, electrical, mechanical, and kinematic characteristics of the vehicle, and generate representations of the vehicle for population of a digital map of the outdoor yard. Furthermore, in some embodiments, user devices 610, 612, and 614 include user interfaces capable of displaying the digital map.

FIG. 7 illustrates block diagram 700 representative of software and/or firmware elements of mapping module 124 of system 100 of FIG. 1 in which the various processes, programs, services, and scenarios disclosed herein may be implemented. In particular, block diagram 700 includes data processor 710, object detector 712, object tracker 714, and probabilistic filter 716.

In operation, mapping module 124 receives input data from other modules of system 100 (e.g., gate module 114, RSU module 120), updates a digital map representative of a digital twin of an outdoor yard reflective of a state of operation of the outdoor yard, and provides an updated digital map to output interface 126 of system 100. In generating updates for the digital map, data processor 710 of mapping module 124 may be configured to receive features extracted by the other modules of system 100, including properties and characteristics of vehicles within the outdoor yard. Data processor 710 processes the features (e.g., converts the data from one format to another format), and provides data to object detector 712 and object tracker 714.

Object detector 712 detects objects (e.g., vehicles, trucks, yard dogs) from the processed features. In some embodiments, this may entail using one or more classification models trained to detect specific objects. In some embodiments, this may entail using recognition models configured to identify trailers and semi-trucks within an outdoor yard. Additionally, object detector 712 may assign a digital identification number (digital ID) to a corresponding detected vehicle. Object detector 712 may provide indications of detected vehicles to object tracker 714.

Object tracker 714 identifies detected vehicles in outdoor yard and uses various tracking techniques to determine a kinematic state of the vehicles as well as projected movements, positions, and orientations of the vehicles. In some embodiments, object tracker 714 may utilize detection models and tracking algorithms to track vehicles detected by object detector 712. In some embodiments, object tracker 714 may utilize feature-based tracking techniques enabled by the features extracted and processed by other modules of system 100.

During times when sensor data is limited or unavailable, such as when sensors are obscured by inclement weather or offline based on a network or power failure, probabilistic filter 716 may be employed to predict movement of detected/tracked vehicles. For example, probabilistic filter 716 may be representative of one or more filters (e.g., a Kalman filter) and/or models capable of tracking an expanded state of a detected vehicle, including its kinematic state indicative of a position of the vehicle, and an extended state of the detected vehicle indicative of one or combination of a dimension and an orientation of the object, within the outdoor yard.

In various embodiments, probabilistic filter 716 includes multiple filters that iteratively predict a current state of a detected vehicle using a prediction model subject to process noise and update the predicted current state based on the current measurement using a measurement model subject to measurement noise. In particular, upon receiving data corresponding to a current state of a detected vehicle (e.g., from object tracker 714), probabilistic filter 716 updates or corrects a predicted current state according to the measurement model connecting the measurements with the predicted current state and subject to measurement noise, to estimate a state for the current iteration. Due to the probabilistic nature of tracking, selection of the measurement noise affects the update. To that end, the selection of the measurement noise affects the estimation of the state, and thereby, the correctness of the selection of the measurement noise can be beneficial to the operation of the probabilistic filter.

Some embodiments are based on the realization that internal variables and/or calculations of probabilistic filter 716 can be used to evaluate correctness of the measurement noise. Specifically, a metric of evaluation of the correctness of the measurement noise can be a likelihood of the measurement noise to correlate the current measurement indicative of the state of the device with the state predicted by the prediction model. In such a manner, the measurement noise is evaluated using internal variables and/or calculations of the probabilistic filter 716 without a need for additional statistical analysis of the measurements outside of performance of the probabilistic filter 716.

It should be noted that the abovementioned example not only illustrates the principles of correlation between state estimation and the measurements but can also be used to implement the estimation of the correlation. However, different embodiments can use different techniques to evaluate the correlation. For example, some embodiments use the evaluation of Kalman gains determined by a Kalman filter to update the predicted current state and covariance of the state estimate, which for an unbiased estimator is the mean-square error (MSE). For instance, one embodiment determines the Kalman gain for each Kalman filter in probabilistic filter 716, determines the updated predicted current state and the updated covariance of the state estimate using the Kalman gain, and determines a likelihood of the measurement noise based on the updated state and covariance based on the Kalman gain. Such calculations are internal to the probabilistic filter 716, i.e., computed anyway to track the state of the device. Hence, calculations of these variables do not require additional resources.

However, some embodiments are based on the realization that while the usage of the internal variables and/or calculations of the probabilistic filter 716 can reduce the computational requirements for the evaluation of the correctness of the measurement noise, the evaluation itself becomes corrupted by internal performance of the probabilistic filter 716. In other words, the correctness of the measurement noise is not necessarily the true correctness reflecting the measurements independent of the probabilistic filter 716, but the correctness from the point of view of the probabilistic filter 716 itself. To address this problem, mapping module 124 may include multiple probabilistic filters with different measurement noises and determine the state of a detected vehicle as a weighted combination of the states estimated by the multiple probabilistic filters with weights of each filter derived from the corresponding evaluation of the likelihood of the measurement noise to correlate the current measurement indicative of the state of the detected vehicle predicted by the prediction model of the filter. In such a manner, different measurement noises can be considered without a need to analyze the statistical properties of the measurements.

Some embodiments are based on a recognition that the expanded state of the object can be estimated using a center-truncated distribution and corresponding underlying untruncated Gaussian distribution. As such, in some embodiments, probabilistic filter 716 further estimates a center-truncated distribution to predict a trajectory of a detected vehicle within the outdoor yard while sensor data is unreliable or unavailable. The center-truncated distribution may be based on a truncation interval at the center of a curve, providing for a smaller probability for the measurements at the center of the center-truncated distribution inside of the truncation intervals, and a larger probability for the measurements outside of the truncation intervals. To that end, some embodiments are based on a realization that the center-truncated distribution can be used to represent real-world movements of vehicles within the outdoor yard.

The center-truncated distribution is a truncation of underlying untruncated Gaussian distribution according to particular truncation intervals. The underlying Gaussian distribution is centered at a mean of the distribution, and variance measures the spread and width of the distribution. To that end, some embodiments are based on an objective of estimating the center-truncated distribution that fits the measurements and, subsequently, the mean and the variance of the underlying Gaussian distribution corresponding to the estimated center-truncated distribution. Some embodiments are based on a recognition that the mean of the underlying Gaussian distribution indicates the position of the detected vehicle in an expanded state and the variance of the underlying Gaussian distribution indicates the dimension and the orientation of the detected vehicle in the expanded state. To that end, some embodiments are based on a recognition that using the center-truncated distribution and underlying Gaussian distribution pair, both a kinematic state and the expanded state of the object can be estimated. Also, this simplifies parameterization of tracking the expanded state. Furthermore, using the center-truncated and underlying Gaussian distribution pair, dimensionality of the computation is reduced.

FIG. 8 illustrates computing system 801 that is representative of any system or collection of systems in which the various processes, programs, services, and scenarios disclosed herein may be implemented. Examples of computing system 801 include, but are not limited to, desktop and laptop computers, tablet computers, mobile computers, smart phones, and the like. Examples may also include server computers, web servers, cloud computing platforms, and data center equipment, as well as any other type of physical or virtual server machine, container, and any variation or combination thereof.

Computing device 801 may be implemented as a single apparatus, system, or device or may be implemented in a distributed manner as multiple apparatuses, systems, or devices. Computing device 801 includes, but is not limited to, processing system 802, storage system 803, software 805, communication interface system 807, and user interface system 809. Processing system 802 is operatively coupled with storage system 803, communication interface system 807, and user interface system 809.

Processing system 802 loads and executes software 805 from storage system 803. Software 805 includes and implements mapping process(es) 806, which is representative of the outdoor yard digital twin generation and mapping methods and processes described above. When executed by processing system 802, software 805 directs processing system 802 to operate as described herein for at least the various processes, operational scenarios, and sequences discussed in the foregoing implementations. Computing device 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, digital signal processors, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including mapping process(es) 806) may be implemented in program instructions and among other functions may, when executed by processing system 802, direct processing system 802 to operate as described with respect to the various operational scenarios, sequences, and processes illustrated herein. For example, software 805 may include program instructions for implementing the inference and training processes described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing system 801 is representative) overall from a general-purpose computing system into a special-purpose computing system customized to perform digital twin generation and management in an optimized manner. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A digital yard system comprising:
a memory configured to store a dynamic map of the yard including ingress, egress, and landmark locations of the outdoor yard; and
a processor coupled with executable instructions forming modules of the yard management system and configured to execute the modules of the yard management system to update the dynamic map of the outdoor yard, wherein the modules executed by the processor include:
an input interface configured to accept images of a scene at an ingress location, an egress location, and landmark locations of the outdoor yard;
an output interface configured to output the updated dynamic map of the outdoor yard;
a gate check-in module configured to:
accept a first image of a vehicle entering the outdoor yard at the ingress location;
extract from the first image visual features of one or a combination of visual appearance and visual markings on the vehicle;
generate a digital identifier of the vehicle from the visual features of the first image;
add to a list of vehicles present in the outdoor yard a digital representation of the vehicle identified by the digital ID; and
update the dynamic map by reflecting a state of the vehicle identified by the digital identifier on the dynamic map at the ingress location;
a roadside-unit (RSU) module configured to:
accept a second image of the vehicle at a corresponding landmark location of the landmark locations;
extract from the second image the visual features of the vehicle;
generate the digital identifier of the vehicle from the visual features of the second image;
verify existence of the vehicle with the digital identifier in the list of vehicles present in the outdoor yard; and
update the dynamic map by reflecting the state of the vehicle identified by the digital identifier on the dynamic map at the corresponding landmark location; and
a gate check-out module configured to:
accept a third image of the vehicle exiting the outdoor yard at the egress location;
extract from the third image the visual features of the vehicle;
generate the digital identifier of the vehicle from the visual features of the third image; and
remove the digital identifier of the vehicle from the list and the dynamic map of the outdoor yard.

2. The digital yard system of claim 1, further comprising:
a set of sensors arranged at designated locations to image the yard at the ingress location, the egress location, and the landmark locations to produce images including the first, second, and third images.

3. The digital yard system of claim 1, wherein the digital identifier comprises a virtual representation of the vehicle indicative of the state of the vehicle in association with the digital representation of the vehicle, wherein the state of the vehicle comprises one or a combination of a location and an orientation of the vehicle.

4. The digital yard system of claim 3, wherein to generate the digital identifier of the vehicle from the visual features of the first image, the gate check-in module is configured to generate the digital identifier using one or a combination of a three-dimensional modeling process, a vector graphics process, a spectral mapping process, and a thermal imaging process, applied to the visual features.

5. The digital yard system of claim 3, wherein to generate the digital identifier of the vehicle from the visual features of the second image, the RSU module is configured to generate the digital identifier using one or a combination of a three-dimensional modeling process, a vector graphics process, a spectral mapping process, and a thermal imaging process, applied to the visual features.

6. The digital yard system of claim 3, wherein to generate the digital identifier of the vehicle from the visual features of the third image, the gate check-out module is configured to generate the digital identifier using one or a combination of a three-dimensional modeling process, a vector graphics process, a spectral mapping process, and a thermal imaging process, applied to the visual features.

7. The digital yard system of claim 1, wherein the modules executed by the processor further include a tracking module, comprising:
a sensing unit configured to receive measurements of an active sensor and estimate a kinematic state of an object in the outdoor yard indicative of one or a combination of a location and a velocity of the object; and
an assignment unit configured to associate the kinematic state of the object with a digital identifier of a vehicle, to track the movement of the vehicle associated with the digital identifier within the outdoor yard, and to update the dynamic map based on the tracked movement of the vehicle having the digital identifier.

8. The digital yard system of claim 7, further comprising:
a set of active sensors including one or a combination of a radar sensor, a LiDAR sensor, and a radio frequency sensor, the set of active sensors arranged to sense movement within the outdoor yard to produce the measurements for the tracking module.

9. The digital yard system of claim 7, wherein the sensing unit is configured to estimate an expanded state of the object indicative of one or a combination of a dimension and an orientation of the object, and wherein the assignment unit associates the vehicle with the digital identifier from the list by comparing the dimension of the object with dimensions of the vehicle associated with the digital identifier.

10. The digital yard system of claim 9, wherein the tracking module updates the dynamic map by mapping the dimensions and orientations of the vehicle on the dynamic map.

11. The digital yard system of claim 7, wherein the tracking module includes a Kalman filter tracking the vehicle using a process model including a motion model of the vehicle subject to process noise and a measurement model of the measurements of the active sensor subject to measurement noise.

12. The digital yard system of claim 11, wherein the Kalman filter uses a compound measurement model with different variances of the measurement noise to adapt the Kalman filter to different qualities of the measurements.

13. The digital yard system of claim 1, wherein:
to update the dynamic map by reflecting a state of the vehicle identified by the digital identifier on the dynamic map at the ingress location, the gate check-in module is configured to populate the dynamic map with a representation of the state of the vehicle in association with the digital identifier of the vehicle.

14. The digital yard system of claim 13, wherein:
to update the dynamic map by reflecting the state of the vehicle identified by the digital identifier on the dynamic map at the corresponding landmark location, the RSU module is configured to update the representation of a state previously populated on the dynamic map with the state of the vehicle identified by the digital identifier on the dynamic map at the corresponding landmark location.

15. The digital yard system of claim 1, wherein to output the updated dynamic map of the outdoor yard, the output interface is configured to display the updated dynamic map on a graphical user interface of a user device.

16. The digital yard system of claim 1, wherein the dynamic map provides an interface connecting the digital twin of the state of operation of the outdoor yard to a real-world state of operation of the outdoor yard based on the states of vehicles in the outdoor yard indicated by at least the digital identifier on the digital map.

17. A method for maintaining a digital twin of a state of operation of an outdoor yard of the distribution center indicative of changes in states of vehicles in the outdoor yard, the method comprising:
receiving a first image of a vehicle entering the outdoor yard at an ingress location;
extracting from the first image visual features of one or a combination of visual appearance and visual markings on the vehicle;
generating a digital identifier of the vehicle from the visual features of the first image;
adding to a list of vehicles present in the outdoor yard a digital representation of the vehicle identified by the digital identifier; and
generating a dynamic map for the digital twin of the outdoor yard by reflecting a state of the vehicle identified by the digital identifier on the dynamic map at the ingress location;
receiving a second image of the vehicle at a landmark location of the outdoor yard;
extracting from the second image the visual features of the vehicle;
generating the digital identifier of the vehicle from the visual features of the second image;
verifying existence of the vehicle with the digital identifier in the list of vehicles present in the outdoor yard;
updating the dynamic map by reflecting the state of the vehicle identified by the digital identifier on the dynamic map at the landmark location;
receiving a third image of the vehicle exiting the outdoor yard at an egress location of the outdoor yard;
extracting from the third image the visual features of the vehicle;
generating the digital identifier of the vehicle from the visual features of the third image; and
removing the digital identifier of the vehicle from the list and the dynamic map of the outdoor yard.

18. The method of claim 17, wherein the digital identifier comprises a virtual representation of the vehicle indicative of the state of the vehicle in association with the digital representation of the vehicle, wherein the state of the vehicle comprises one or a combination of a location and an orientation of the vehicle, and wherein generating the digital identifier from the visual features comprises using one or a combination of a three-dimensional modeling process, a vector graphics process, a spectral mapping process, and a thermal imaging process, applied to the visual features.

19. The method of claim 17, further comprising:
receiving measurements of an active sensor and estimating a kinematic state of an object in the outdoor yard indicative of one or a combination of a location and a velocity of the object; and
associating the kinematic state of the object with a digital identifier of a vehicle;
tracking the movement of the vehicle associated with the digital identifier within the outdoor yard; and
updating the dynamic map based on the tracked movement of the vehicle having the digital identifier.

20. A yard management system for maintaining a digital twin of a state of operation of an outdoor yard of the distribution center indicative of changes in states of vehicles in the outdoor yard, the yard management system comprising:
a memory configured to store a dynamic map of an outdoor yard of a distribution center and program instructions forming modules of the yard management system; and
a processor coupled to the memory and configured to execute the modules to update the dynamic map of the outdoor yard, wherein the modules comprise:
an input interface module configured to receive sensor data associated with the outdoor yard and with the vehicles in the outdoor yard;
sensor modules configured to, for each vehicle of the vehicles in the outdoor yard:
generate a digital identification associated with a vehicle based on determining visual features of the vehicle from the sensor data;
determine a state of the vehicle relative to the outdoor yard based on the sensor data; and
provide an indication of the state of the vehicle in association with the digital identification of the vehicle to an output interface module; and
an output interface module configured to update the dynamic map of the outdoor yard with the indications of the states of the vehicles based on reflecting the states of the vehicles relative to the outdoor yard on the dynamic map, and to output the dynamic map of the outdoor map.
